(19) United States
(12) Patent Application Publication
(10) Pub. No.: US 2003/0188302 A1
(43) Pub. Date: Oct. 2, 2003

(54) Method and apparatus for detecting and decomposing component loops in a logic design

(76) Inventors: Liang T. Chen, Saratoga, CA (US); Jeffrey Broughton, Pleasonton, CA (US); Derek Pappas, Union City, CA (US)

Correspondence Address: ROSENTHAL & OSHA L.L.P. / SUN, 1221 MCKINNEY, SUITE 2800, HOUSTON, TX, 77010, US

(21) Appl. No.: 10/112,378

(22) Filed: Mar. 29, 2002

(51) Int. Cl. G06F 9/45

(52) U.S. Cl. 717/160

(57) ABSTRACT

A method and apparatus for detecting and decomposing component loops in a logic design is described. The invention first detects any component loops when the compiler schedules the processing order of the combinational logic components in the digital circuit design. To identify component loops, the compiler levelizes the design and sorts the combinational logic components, making sure that no true combinational logic loops exist. If the sorting fails, a component loop exists, and the compiler identifies such components and selects one or more of the components to be split. Next, the invention corrects the component loops by splitting a component into multiple sub-components. By splitting a component into multiple sub-components, the output of the split component no longer provides input to another component, and hence, the component loop is broken. In this way, the compiler is able to generate executable code configured to run in a cycle-based simulation system or in a general purpose computing environment, by avoiding false component loops.

### BACKGROUND OF THE INVENTION

A. Field of Invention

This invention relates to a compiler for a hardware description language configured for cycle-based simulation, and more specifically to a compiler enhancement that broadens the application of cycle-based simulation.

Portions of this disclosure contain material that is subject to copyright protection. The copyright owner has no objection to the facsimile reproduction by anyone of the patent document or the patent disclosure as it appears in the Patent and Trademark Office file or records, but otherwise reserves all rights whatsoever. Sun, Sun Microsystems, the Sun logo, Solaris, and Java are trademarks of Sun Microsystems, Inc. in the United States and other countries.

B. Background Art

It is expensive to design and manufacture electronic circuits, especially digital circuits. Therefore, to ensure that a digital design produces the appropriate results it is very important for electronic hardware designers to thoroughly test and analyze it prior to manufacturing it. One analysis method involves the simulation of a digital system using computer software in a cycle-based simulation.

Prior art cycle-based simulation schemes are constrained, especially when a digital system has a complex design. For example, the design source codes must be processed by a system known as a “compiler” before it can be executed in a cycle-based simulator. The compiler must analyze the design and schedule the logic instructions into the proper execution order. Current compilers cannot sort combinational logic components and schedule logic instructions into the proper execution order when there are false combinational logic loops (also known as “component loops”). Therefore, current cycle-based simulation schemes impose restrictive design rules and coding styles.

A method is needed that can handle the compilation of designs having component loops, and thereby relax the design rules which would otherwise be required in prior art cycle-based simulation.

In the design and simulation of digital systems, a hardware design, such as a computer or a component of a computer, is often described or modeled in a Hardware Description Language (HDL) such as Verilog or Very High Speed Integrated Circuit Hardware Description Language (VHDL), or a programming language such as C or C++ or other language. For purposes of illustration, Verilog examples will be described herein, though the techniques described are applicable to other HDL languages (e.g., VHDL), structural level netlists, and graphical design representations as well.

Once a system is described in an HDL, the HDL description may be simulated in hardware, such as by programming a FPGA (field-programmable gate array) device based on the HDL description, or the HDL description may be rendered or compiled into a binary image for execution on one or more processors. A designer is then able to simulate the HDL model or description to achieve functional verification prior to committing to the expensive process of chip fabrication.

Cycle-Based Simulation

Cycle-based simulation is applicable to synchronous digital systems and may be utilized to verify the functional correctness of a digital design. Cycle-based simulators use algorithms that eliminate calculations which do not affect the simulation results to achieve improved performance in verifying system functionality. Typically, in a cycle-based simulator the entire system is evaluated once at each active clock edge. Therefore, discrete component evaluations and re-evaluations are unnecessary upon the occurrence of every event.

FIG. 1A is a block diagram of a digital circuit with various combinational logic components A, B, and C, and clock triggered flip-flops F1 and F2. A flip-flop is a digital device capable of storing a single binary bit that is loaded typically on a rising edge of a clock signal. D1 and D2 represent the input signals to flip-flops F1 and F2, respectively.

Digital clocks are used to synchronize the operation of various circuit components by generating sequential digital signals. FIG. 1B illustrates the state diagrams for clocks C(1) and C(2) used to synchronize the digital circuit of FIG. 1A. Digital clocks are individual timing devices that generate a uniform electrical frequency (periodic signal) from which digital pulses are created. The uniformly sequential clock pulses are used to synchronize different events and functions within a circuit.

Component Loops

When an HDL design compiler generates cycle-based simulation code, the compiler must schedule the execution order of the combinational logic components in such a way that the simulation of all components that indirectly or directly affect a given signal occurs before the simulation of other components as an input.

In software cycle-based simulation, the HDL description is executed as multiple concurrent processes (typically very large in number) by a computer or other processor-based system. The HDL description typically models processes with reference to a fixed time interval or simulation unit (e.g., integer values in nanoseconds). For a synchronous design, those logic processes may be controlled by synchronizing clocks. The duration between the active clock edges of the synchronizing clocks is used to define a simulation cycle. Cycle-based simulation is carried out by stepping through the simulation cycle, executing every process exactly once during a given simulation unit interval before proceeding to the next simulation cycle.

In a cycle-based simulation, a digital circuit is evaluated each clock cycle. A clock cycle refers to the period between one clock signal and the next. Referring to FIG. 1B, the state diagram of clock C(1) enclosed between vertical lines 1 and 5, represents a clock cycle for clock C(1). Thus, referring to FIG. 1A, in a cycle-based simulation, the circuit components such as combinational logic A, B, and C are evaluated based on the value generated by F1 and F2 at the end of each clock cycle, e.g. at the points indicated by vertical lines on the drawing.

A true combinational logic loop occurs when a component generates an output that is (through zero or more intervening components) an input to the original component without any intervening sequential logic component (state device). An example of a true combinational gate to gate logic loop is shown in FIG. 2, where the logic data path from pin a of component G1 goes through pin z of G1 and through pin z of G2 and comes back to pin a. If a true combinational logic loop is detected in a design, that design cannot be simulated on a cycle-based simulator.

When an HDL design represents a design above the gate level (RTL level where components and signals may be multiple bits wide), there may exist a combinational logic loop among the high level components that would not be present in a gate level design. Such combinational logic loops are called “false combinational logic loops” or “component loops”. They are false because the underlying gate level design does not have such loops. Component loops are disadvantageous because as with true combinational logic loops, the compiler cannot schedule a proper execution order.

FIG. 3 is a block diagram illustrating a component loop. Prior art compilers cannot sort component A and component B into the proper execution order because the output of component B provides the input to component A. A method is needed that can compile component loops for cycle-based simulation in a simulation system or in a general purpose computing environment.

### SUMMARY OF THE INVENTION

A method and apparatus for detecting and decomposing component loops in a logic design is described. In accordance with the present invention, a compiler detects any component loops when the compiler schedules the processing order of the combinational logic components in a digital circuit design. Next, the invention reconfigures the component loops by splitting a component into multiple sub-components. By splitting a component into multiple sub-components, the output of the split component no longer provides input to another component, and hence, the component loop is broken.

To identify component loops, the compiler levelizes the design and sorts the combinational logic components, making sure that no true combinational logic loops exist. If the sorting fails, a component loop exists, and the compiler identifies such components and selects one or more of the components to be split.

Embodiments described herein may be applied individually, or in combination. In one embodiment, the invention splits the bus level terminals of a component into bit level terminals. In another embodiment, the invention splits a group of independent sequential assign statements in a component. In another embodiment, the invention splits buses or statements which appear in multiple branches in a conditional construct type component. In this way, the compiler is able to generate executable code configured to run in a cycle-based simulation system or in a general purpose computing environment, by avoiding component loops.

### BRIEF DESCRIPTION OF THE DRAWINGS

These and other features, aspects and advantages of the present invention will become better understood with regard to the following description, appended claims and accompanying drawings where:

FIG. 1A is a block diagram illustrating a prior art digital circuit including flip-flops.

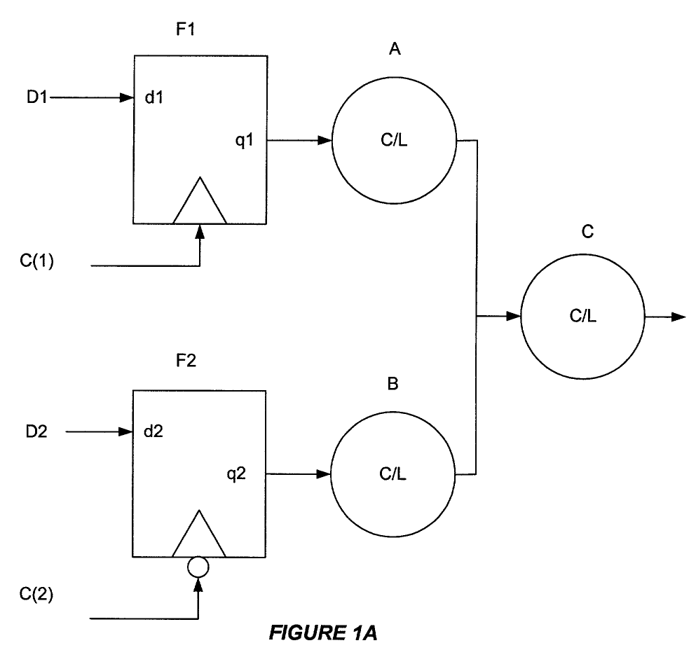

FIG. 1B is a prior art state diagram illustrating non-overlapping clocks C(1) and C(2).

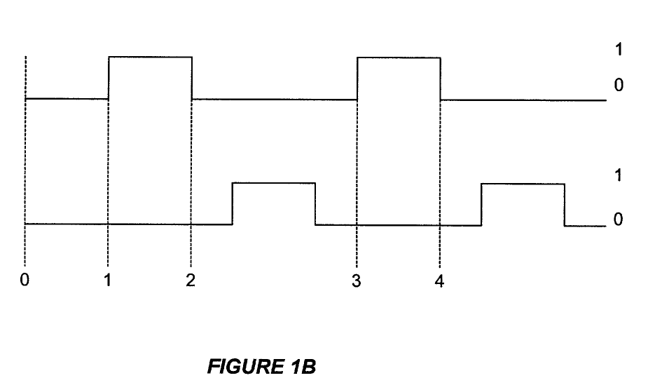

FIG. 2 illustrates a true combinational logic loop.

FIG. 3 is a prior art block diagram illustrating an example of a false component loop.

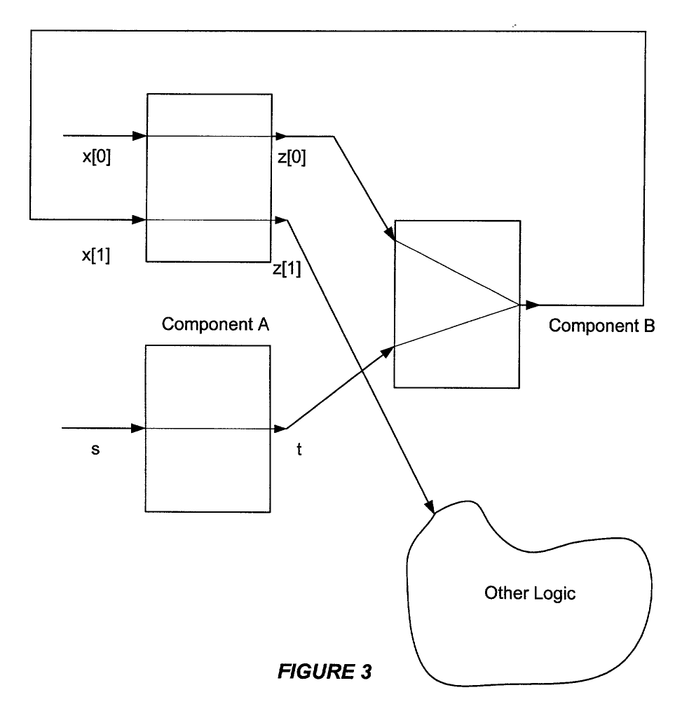

FIG. 4 is a flow diagram of a compiler in accordance with the present invention.

FIG. 5 is a flow diagram of design analysis in accordance with the present invention

FIG. 6 is a flow diagram of a levelization process in accordance with the present invention.

FIG. 7 is a flowchart showing a second example method of how to detect and eliminate component loops in accordance with the present invention.

FIG. 8 is a flowchart showing an example method of how to detect components for splitting according to the present invention.

FIG. 9 is a block diagram of a general purpose computing environment useful when practicing the present invention.

### DETAILED DESCRIPTION OF THE INVENTION

A method and apparatus for detecting and decomposing component loops in a logic design is described. In the following description, numerous specific details are set forth in order to provide a more thorough understanding of the present invention. It will be apparent, however, to one skilled in the art that the present invention may be practiced without these specific details. Further, this invention in one or more embodiments may be implemented in the form of hardware and/or software.

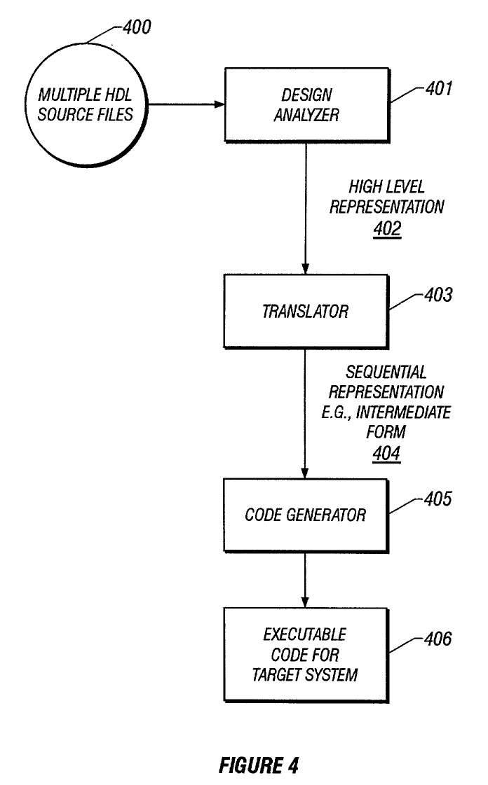

As illustrated in FIG. 4, a present invention simulation compiler comprises a design analyzer 401 that receives input in the form of HDL source files 400 (e.g., Verilog modules) and generates a high-level representation 402 of the simulation design, ordered for single-pass execution in a cycle-based system. This high-level representation 402 may include, for example, a component object reference database containing shared information for component types, a component instance database containing information for specific component instances as well as flattened connectivity information, components (instances) collected by type, a list of simulation variables, and a sorted component list, in which the sort order corresponds to the execution order for single-pass, cycle-based execution.

A translator 403 receives the high level representation 402 and translates the operations into a sequential representation (or intermediate form) that describes the cycle-based simulation operations. The sequential representation 404 is transformed by code generation process 405 into executable code 406 for a target simulation system. It will be apparent that the techniques described in association with the design analyzer 401 render an elaborated logic design suitable for use with all classes of computer-aided logic design tools. For example, the simulator described herein, a power-analysis, or a fault-grading tool.

Furthermore, the translator 403 may direct execution of the program through a variety of mechanisms, including production of a sequential representation 404 described herein, production of a program in a high level language such as C, production of assembly language or binary instructions for the target simulation system, or by direct interpretation of the prescribed operations.

The design analyzer 401, translator 403, and code generator 405, may be used with any target simulation system. For example, the sequential representation 404 may be transformed into a sequential program for execution on a general purpose or application specific computer, or may be partitioned into a plurality of threads for execution on a Multiple Instruction Multiple Data (MIMD) computer.

Design Analyzer

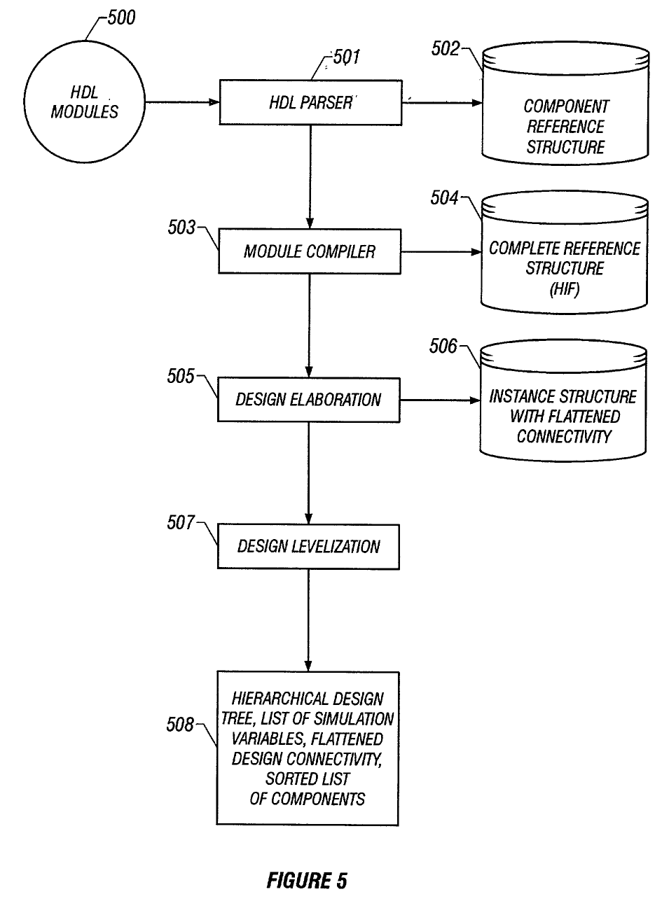

The flow of an embodiment of the design analyzer 401 is illustrated in the flow diagram of FIG. 5A. One or more HDL modules 500 are provided to HDL parser 501. The modules are then parsed to generate the component reference database 502. Component reference database 502 contains one component object definition for each component appearing in the design source code. Those component object definitions provide the basis for component instantiation in later stages. The module compiler 503 expands the object definitions from reference database 502 and extracts the logic modeling and pin information for each component. A logic inference function is applied to each component to determine the logic content. A complete reference database 504 in a high-level abstract representation, referred to herein as HDL intermediate form (HIF) or Verilog intermediate form (VIF), is generated after the module compilation.

In the design elaboration phase 505, the compiled design modules are linked together into a hierarchical tree, from which instances of component objects are recursively generated. Binding is performed and simulation variables are created for local nets. The output of the design elaboration phase is an elaborated instance database 506 with flattened connectivity information. Design levelization phase 507 operates upon instance database 506 to collect all components by logic type and formulates a hierarchical design tree, a sorted list of components in execution order, a list of simulation variables, and a flattened design connectivity 508.

Design Levelization

Design levelization is performed in embodiments of the invention to facilitate the generation of cycle-based simulation code that can evaluate all simulated elements exactly once to arrive at a steady state, for a given simulation clock cycle, with a single pass of the generated code. To this end, the instance database 506 generated by the design elaborator is analyzed, to collect components (i.e., instances) by type (e.g., clock logic, sequential logic, data logic, initial logic, etc.), as well as to identify any possible conflict issues, such as combinational logic loops. It is in this step that the new method to resolve false combinational loops is applied.

After the levelization analysis is performed, the logic components are sorted according to type (combinational, sequential, and the like) to determine an execution order that will result in a single pass solution (i.e., one-time evaluation of each component per simulation clock cycle).

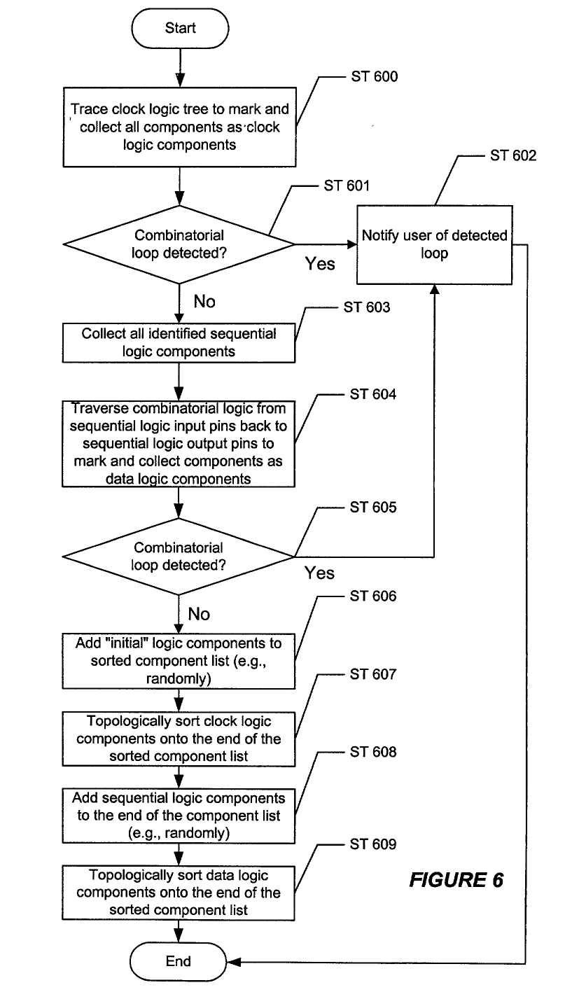

FIG. 6 is a flow diagram of one embodiment of a levelization process. At block 600, clock logic trees are traversed at the logic signal level in order to determine whether combinational logic loops exist in the clock logic. Clock logic refers to those combinational components that must be evaluated prior to a clock signal reaching the clock pin of a sequential logic device. To find clock logic, given a user defined clock source signal, a tracing routine traces through all logic nets and combinational logic components until each branch in the clock tree reaches a terminus at a known clock pin of a sequential logic component. Each combinational logic component passed in the trace is marked and collected as a clock logic component.

At block 601 if a combinational logic loop was detected, the method is caused, at block 602, to notify the user of a possible design error. The method then terminates until the error is fixed.

At block 603, all sequential logic components are collected into groups. At block 604, each sequential logic input pin is traversed backwards, through all intervening combinational logic components, until the output pin of another sequential logic component is reached. All combinational logic components traversed in this manner are marked and collected as data logic components.

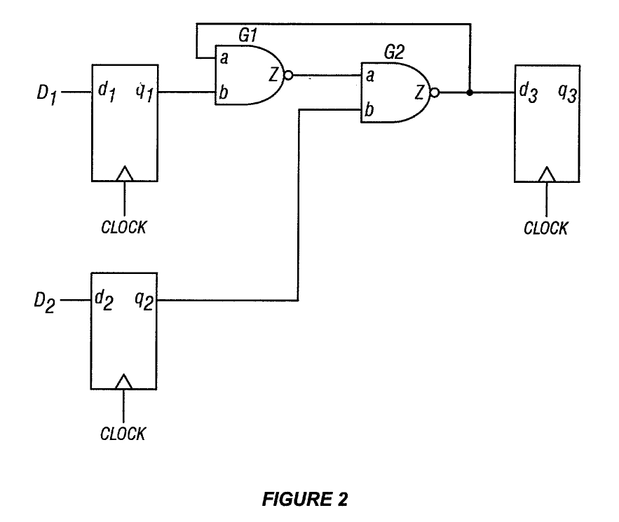

In one embodiment, during the traversal block 604, a levelization process detects any true combinational logic loops. A true combinational logic loop is defined as a logic data path from a design node feeding back to the same node through at least one combinational logic component. An example of a true combinational logic loop is shown in FIG. 2 and has been described previously. Such loops prevent single-pass evaluation of the simulated circuit. The reason for this is that the logical value at the input of a previously evaluated component may be altered by the logic loop, requiring re-evaluation of the component until a loop steady state is achieved. Because re-evaluation is contrary to the strict requirement of a single pass solution, at block 605 it is determined whether a true combinational logic loop exists, and, at block 602, the user is notified in some manner (e.g., an error or warning is indicated in an alert window or logged to a file) of a loop detection event, and the method ends.

In block 606, any “initial” logic components are added to the sorted component list (e.g., in any order). “Initial” logic components are components associated with “initial” Verilog statements, or other similar HDL constructs, that are executed once at the beginning of a cycle-based simulation (e.g., to initialize specific simulation variables). These logic components are placed first in the sorted component list. The relative ordering of the initial logic components may be randomly determined, for example.

Once all components have been collected into separate groups, (e.g., clock, logic, sequential logic, and data logic), the clock logic components, at block 607, are topologically sorted into the list. the final order of the sorted list specifies the order for evaluation of those components.

The HDL Design

A design with component loops in the clock logic will cause a failure in sorting the clock components. Therefore, the compiler detects the component loops during clock logic component sorting. If a component loop is detected, one or more components are identified to be split and the sorting resumes after the component is split.

The order in which the respective clock logic components are placed into the sorted component list may be determined topologically. For example, during traversal of the clock tree, each node between components may be labeled with a level number, the source clock signal representing level 0. The output of each clock logic component is given a label that is one greater than the maximum of the levels assigned to its input pins. The clock logic components can then be sorted in dependency order according to the levels assigned to their output pins, upward from one. Components with the same level numbers can be placed in an arbitrary order.

At block 608, the sequential logic components are added to the sorted component list.

The group order (e.g., clock logic components before sequential logic components) ensures that the inputs for a given type of component have been evaluated prior to evaluation of that given component. For example, it is safe to evaluate sequential logic components once all clock logic components have been evaluated, and it is safe to evaluate all data logic components once all sequential logic components have been evaluated. The task of detecting and splitting component loops is performed during the process of sorting the components.

At block 609, all data logic components are topologically sorted and added to the sorted component list. A design with component loops in the data logic will cause a failure in sorting the data components. Therefore, the compiler detects the component loops during data logic component sorting. If a component loop is detected, one or more components are split and the sorting resumes. As with the clock logic components, the data logic components are ordered in topological fashion. A similar mechanism (i.e., assigning levels during traversal from an origin, for instance a sequential logic component output pin), may be used to sort the data logic components in a manner that accounts for data dependencies.

The output of the design levelization phase is a sorted list of components in execution order, as well as a list of simulated variables. The blocks of sorting the collected components may be considered part of a translation phase 403 (see FIG. 4), with prior component collection blocks considered a logic network analysis portion of the design analysis phase 402 (see FIG. 4).

Detecting Component Loops

The compiler sorts data logic components and clock logic components topologically. A component will be put into the sorting list only when all the preceding components which affect its inputs have previously been put into the sorting list. Therefore, when sorting a target component, the compiler will go through every target component input in a depth-first search recursively to identify each component connected to the target components inputs, and add all those other components to the sorting list. After all components connected to the target component inputs have been added into the sorting list, the target component is then added to the list.

In the depth-first search path, every encountered component may be marked with a VISIT flag. If during a depth-first search, a component in the next level is already marked with the VISIT flag, a component loop is detected and all the components in the loop are stored in an array.

When the compiler sorts the clock logic components, the components that are directly driven by clock sources are the initial target components. The compilers starts from each initial target component to traverse the design graph recursively toward the sequential logic clock pins. When the compiler sorts the data logic components, the components that drive sequential logic inputs or primary outputs are the initial target components. The compiler starts from each initial target component to traverse the design graph recursively toward the sequential logic outputs or primary inputs.

If the sorted list of components in execution order cannot be obtained as output of the sorting phase , it is because one or more component loops (i.e., false combinational logic loops) exist. A component loop may be discovered, for instance, when a back-edge is discovered during a topological traversal of the graph. A design connectivity graph consists of design nodes connected by the edges. An edge is directional from a given node to its fanout node to model the signal flow. When a edge comes from a later stage node to reach a previously encountered node, this edge is called back edge. If component loops exist, the invention identifies components that may be split according to component splitting rules and then splits those components.

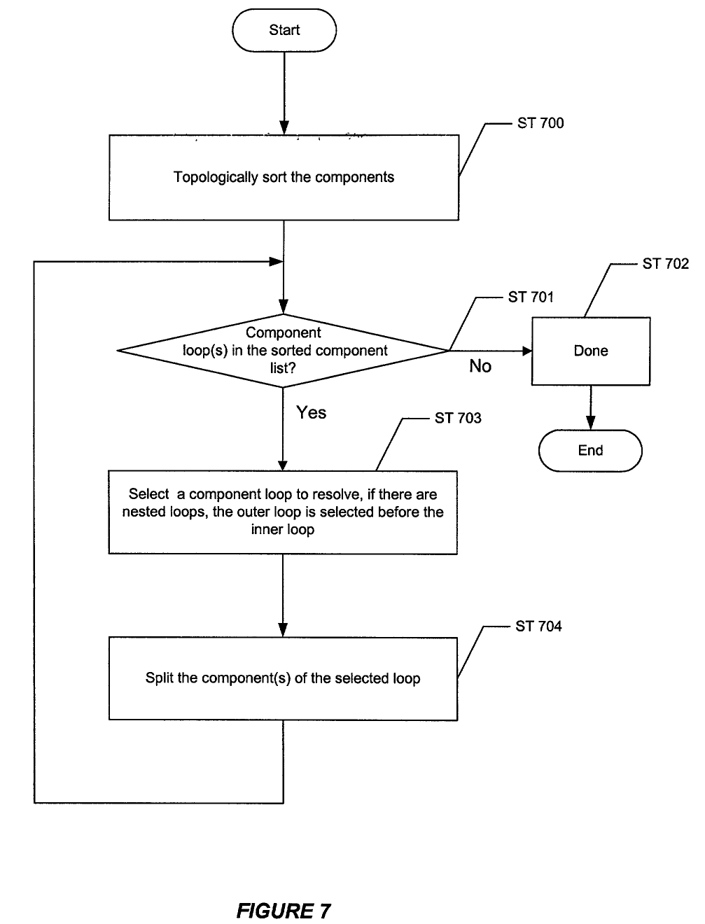

FIG. 7 is a flowchart showing a second example method of how to detect and eliminate component loops in accordance with the present invention. At block 700, components in the design have been topologically sorted. Next, it is determined at block 701 whether a component loop exists. If no loops exist, the process ends at block 702. If component loops exist, the method proceeds at block 703 where a component loop is chosen to be resolved. If nested loops exist, the outer loop is resolved prior to the inner loop being resolved.

Components within component loops are identified for splitting and are split at block 704. Then, the process re-determines whether a component loop exists at block 701. If not, the method is complete and terminates at block 702. Otherwise, the process repeats at block 703.

The component loop detection mechanism applies to clock logic and combinational logic independently. When a component loop consists of some components in combinational logic and some components in clock logic, it may be clock logic components driving the combinational logic components (the loop will be detected in combinational logic sorting), combinational logic components driving clock logic components (the loop will be detected in clock logic sorting), or the mixture of the above two (the loop will be detected both in clock logic sorting and combinational logic sorting).

Component Splitting Rules

At block 704 of FIG. 7, the invention identifies components that may be split in the component loop. A component will be checked, at block 704, using the following modeling rules to determine if and how to split the components.

1) If all the terminals (inputs and outputs) in the component are bus terminals and the widths of the bus terminals are the same, the component may be split into multiple bit-level components;

2) If the component consists of independent assign statements, the component may be split into multiple sub-components where each sub-component comprises a disjointed subset of the independent assign statements; and

3) If the component has the same set of output variables in every branch of a conditional construct type component, the component may be split into multiple sub-components where each sub-component comprises a single output in every branch of the conditional construct.

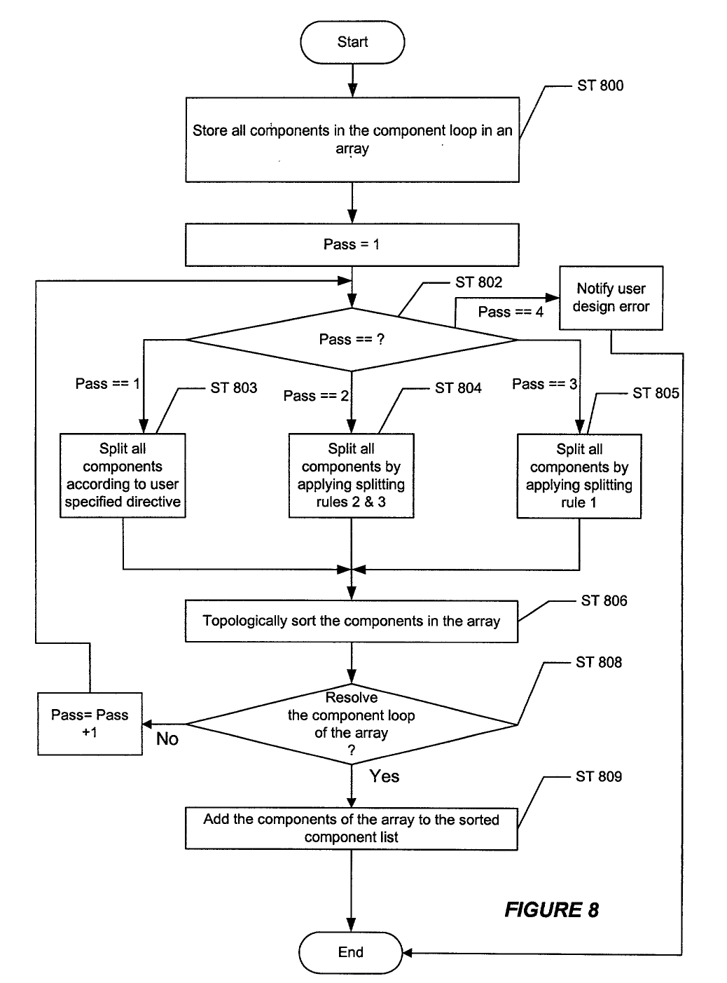

FIG. 8 is an exemplary method accomplishing the requirements of block 704 (previously described). In this method, the compiler provides a compiler directive called “split_component” which allows a user wishes to manually specify which components to split using the split_component directive. If the user does not use the split_component directive, the compiler will automatically identify the components to split.

First, all the components in a loop will be stored in an array at block 800. In this method, a maximum of three passes are made through the loops, in order to properly split them.

At block 802 it is determined how many passes have been previously made through the data. If this is the first pass and user directives exist to split particular components in a particular way, the method proceeds at block 803 when the components are split according to those user directives. If no user directives exist, the method assumes a first pass has been accomplished, and the method proceeds at block 804, as described below.

The method then proceeds at block 806 where all components in the array are topologically sorted.

At block 808 it is determined whether the component loop was resolved. If yes, the method ends when, at block 809, the components of the array are added to the sorted list.

If, at block 802 it is determined that a first pass has been made, but not a second pass, the method proceeds at block 804 where splitting of components is accomplished using the following previously described steps. If the component consists of independent assign statements, the component may be split into multiple sub-components where each sub-component comprises a disjointed subset of the independent assign statements; and If the component has the same set of output variables in every branch of a conditional construct type component, the component may be split into multiple sub-components where each sub-component comprises a single output in every branch of the conditional construct.

The method proceeds again at block 806.

If, at block 802 it is determined that a third pass has been made, , the method proceeds at block 805 where splitting of components is accomplished using the following previously described step. If all the terminals in the component are bus terminals and the widths of the bus terminals are the same, the component may be split into multiple bit-level components.

The method proceeds again at block 806.

Component Splitting Examples

Examples of splitting components are as follows:

1) Bus terminals of a component are split into bit level terminals;

2) Groups of independent assign statements in a component are split; and

3) Buses or statements which appear in multiple branches in a conditional construct type component are split.

Other types of components may be split as well.

The following are examples of HDL programs that show the component splitting rules according to \hat{-} the present invention.

1) Splitting the bus terminals of a component into bit level terminal.

Original component:

assign out_z[1:0]=in_a[1:0] & in_b[1:0];

The original component may be split into:

a) assign out_z[1]=in_a[1] & in_b[1] and

b) assign out_z[0]=in_a[0] & in_b[0];

As one can see, the bus terminals (i.e., out_z[1:0]) have been split into bit level terminals (i.e., out_z[0] and out_z[1]).

2) Splitting a group of independent assign statements within a component.

Original component:

always @(a or b)
begin

c = a;
d = b;

end

The original component may be split into:

| | |
|---|---|
| a) | always @( a ) |
| | begin |
| | c = a; |
| | end |
| | and; |
| b) | always @( b ) |
| | begin |
| | d = b; |
| | end |

As one can see, independent assign statements c=a and d=b in component always @(a or b) have been split to separate components always @(a) and always @(b).

3) Splitting buses or statements which appear in multiple branches in a conditional construct type component.

Original component:

always @(sstate or a or b)

begin

if(sstate == 1 ′b1)

begin

out_z[1] = a;
out_z[0] = b;

end

else

begin

out_z[1] = 1;
out_z[0] = 0;

end

end

The original component may be split into:

| | |
|---|---|
| a) | always @(sstate or a) |

begin

if( sstate == 1 ′b1)

out_z[1] = a;

else

out_z[1] 1;

end

and;

| | |
|---|---|
| b) | always @(sstate or b) |

begin

if(sstate == 1 ′b1)

out_z[0] = b;

else

out_z[0] = 0;

end

As one can see, component always @(sstate or a or b) has been split to always @(sstate or a) and always @(sstate or b).

General Purpose Software Execution Environment

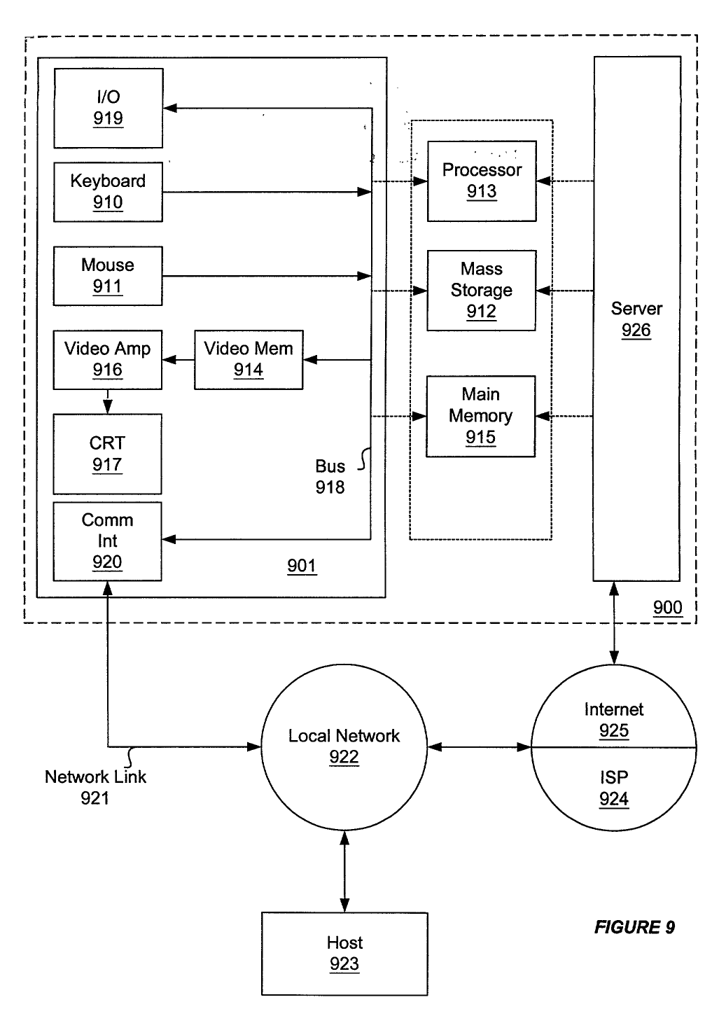

The present invention can be implemented as computer software in the form of computer readable program code executed on a general purpose computer such as computer 900 illustrated in FIG. 9, or in the form of bytecode class files executable within a Java™ runtime environment running on such a computer, or in the form of bytecodes running on a processor (or devices enabled to process bytecodes) existing in a distributed environment (e.g., one or more processors on a network). A keyboard 910 and mouse 911 are coupled to a system bus 918. The keyboard and mouse are for introducing user input to the computer system and communicating that user input to central processing unit (CPU) 913. Other suitable input devices may be used in addition to, or in place of, the mouse 911 and keyboard 910. I/O (input/output) unit 919 coupled to bi-directional system bus 918 represents such I/O elements as a printer, AN (audio/video) I/O, etc.

Computer 900 includes a video memory 914, main memory 915 and mass storage 912, all coupled to system bus 918 along with keyboard 910, mouse 911 and CPU 913. The mass storage 912 may include both fixed and removable media, such as magnetic, optical or magnetic optical storage systems or any other available mass storage technology. Bus 918 may contain, for example, sixty-four address lines for addressing video memory 914 or main memory 915. The system bus 918 also includes, for example, a 64-bit data bus for transferring data between and among the components, such as CPU 913, main memory 915, video memory 914 and mass storage 912. Alternatively, multiplex data/address lines may be used instead of separate data and address lines.

In one embodiment of the invention, the CPU 913 is a SPARC™ microprocessor from Sun Microsystems™, or a microprocessor manufactured by Motorola™, such as the 680X0 processor, or a microprocessor manufactured by Intel™, such as the 80X86, or Pentium processor. However, any other suitable microprocessor or microcomputer may be utilized. Main memory 915 is comprised of dynamic random access memory (DRAM). Video memory 914 is a dual-ported video random access memory. One port of the video memory 914 is coupled to video amplifier 916. The video amplifier 916 is used to drive the cathode ray tube (CRT) raster monitor 917. Video amplifier 916 is well known in the art and may be implemented by any suitable apparatus. This circuitry converts pixel data stored in video memory 914 to a raster signal suitable for use by monitor 917. Monitor 917 is a type of monitor suitable for displaying graphic images.

Computer 900 may also include a communication interface 920 coupled to bus 918. Communication interface 920 provides a two-way data communication coupling via a network link 921 to a local network 922. For example, if communication interface 920 is an integrated services digital network (ISDN) card or a modem, communication interface 920 provides a data communication connection to the corresponding type of telephone line, which comprises part of network link 921. If communication interface 920 is a local area network (LAN) card, communication interface 920 provides a data communication connection via network link 921 to a compatible LAN. Wireless links are also possible. In any such implementation, communication interface 920 sends and receives electrical, electromagnetic or optical signals which carry digital data links representing various types of information.

Network link 921 typically provides data communication through one or more networks to other data devices. For example, network link (21 may provide a connection through local network 922 to host computer 923 or to data equipment operated by an Internet Service Provider (ISP) 924. ISP 924 in turn provides data communication services through the world wide packet data communication network now commonly referred to as the “Internet” 925. Local network 922 and Internet 925 both use electrical, electromagnetic or optical signals which carry digital data links. The signals through the various networks and the signals on network link 921 and through communication interface 920, which carry the digital data to and from computer 900, are exemplary forms of carrier waves transporting the information.

Computer 900 can send messages and receive data, including program code, in communication networks or a distributed environments, through network link 921, and communication interface 920, for example. In the Internet example, server 926 might transmit a requested code for an application program through Internet 925, ISP 924, local network 922 and communication interface 920.

The received code may be executed by CPU 913 (or other processing units in a distributed environment) as it is received, and/or stored in mass storage 912, or other non-volatile storage for later execution. In this manner, computer 900 may obtain application code in the form of a carrier wave. The computer systems described above are for purposes of example only. An embodiment of the invention may be implemented in any type of computer system or programming or processing environment.

Thus, a cycle-based simulation compiler having methods for avoiding component loops has been described, in conjunction with one or more specific embodiments. The invention is defined by the claims and their full scope of equivalents.

1. A method for detecting and deconstructing component loops in a logic design comprising:
detecting one or more false component loops having components; and
splitting at least one said components into a plurality of sub-components.

2. The method of claim 1 wherein said detecting further comprises:
levelizing said logic design;
attempting to sort a plurality of components of said logic design; and
determining when said plurality of components cannot be sorted.

3. The method of claim 2 further comprising:
identifying, using either of user directives or automatic selection, at least one component to be split.

4. The method of claim 3 wherein said one or more components comprise components with multi-bit bus terminals.

5. The method of claim 3 wherein said one or more components comprise groups of independent assign statements.

6. The method of claim 3 wherein said one or more components comprise buses which appear in multiple branches in a conditional construct type component.

7. A compiler that detects and deconstructs component loops in a logic design comprising:
a detector configured to detect one or more false component loops; and
a splitter configured to split said one or more component loops into a plurality of sub-components.

8. The compiler of claim 7 wherein said detector further comprises:
a levelizer configured to levelize said logic design;
a sorter configured to sort a plurality of components of said logic design.

9. The compiler of claim 8 further comprising:
a false component loop identifier configured to identify components which can be split.

10. The compiler of claim 9 wherein said one or more components comprise components with multi-bit bus terminals.

11. The compiler of claim 7 wherein said one or more components comprise groups of independent assign statements.

12. The compiler of claim 7 wherein said one or more components comprise buses which appear in multiple branches in a conditional construct type component.

13. A computer program product comprising:
a computer usable medium having computer readable program code embodied therein configured to avoid component loops in a logic design, said computer program product comprising:
computer readable code configured to cause a computer to detect false component loops; and
computer readable code configured to cause a computer to split component loops into a plurality of sub-components.

14. The computer program product of claim 13 wherein said computer readable code configured to cause a computer to detect further comprises:
computer readable code configured to cause a computer to levelize a design representing said logic design;
computer readable code configured to cause a computer to sort a plurality of components of said logic design; and
computer readable code configured to cause a computer to determine when said plurality of components cannot be sorted.

15. The computer program product of claim 14 further comprising:
computer readable code configured to cause a computer to identify one or more components which can be split.

16. The computer program product of claim 15 wherein said one or more components comprise components with bus terminals.

17. The computer program product of claim 15 wherein said one or more components comprise groups of independent assign statements.

18. The computer program product of claim 15 wherein said one or more components comprise buses which appear in multiple branches in a conditional construct type component.
